(19) United States
(12) Patent Application Publication
(10) Pub. No.: US 2016/0148749 A1
(43) Pub. Date: May 26, 2016

(54) TAP CONFIGURATIONS FOR A TRANSFORMER

(71) Applicant: ABB Technology AG, Zurich (CH)

(72) Inventors: Henry Blake Cooke, Wytheville, VA (US); Will E. Pauley, Bland, VA (US); Chester M. Neal, Narrows, VA (US)

(73) Assignee: ABB Technology AG, Zurich (CH)

(21) Appl. No.: 14/940,357

(22) Filed: Nov. 13, 2015

Related U.S. Application Data
(60) Provisional application No. 62/082,876, filed on Nov. 21, 2014.

(51) Int. Cl. H01F 27/29; H01F 41/00

(52) U.S. Cl. CPC H01F 27/29; H01F 41/00

(57) ABSTRACT

A transformer is provided with a tap configuration that permits only valid tap connections to be made. The transformer has a tap board to align the tap connections in the desired configuration depending on the number of tap positions available for the application. The taps are brought from the coil assembly through to openings on the tap board to allow manual connections between respective taps.

### FIELD OF INVENTION

The present application is directed to tap configurations for various types of transformers.

### BACKGROUND

Taps are connections brought out from transformer coil windings and are used to control the turns ratio of the primary winding to the secondary winding and as a result, the desired voltage, current or phase adjustments may be achieved at the input or output of the transformer. A tap may be connected to another tap without physical restriction, however, not all possible tap connections are valid connections. For example, certain tap connections may short out a transformer coil when the connections are invalid.

### SUMMARY

A transformer having a core having at least one core limb extending between upper and lower yokes, a coil assembly mounted to each at least one core limb, a plurality of taps extending from the surface of the coil winding, at least one cable having first and second ends, the at least one cable first end connected to a corresponding tap at a turn on the coil winding and the cable second end providing a connection surface for connecting with other ones of the taps and a tap board having slots through which corresponding ones of the cable second ends extend to provide a connection surface, each of the taps positioned apart from other ones of the taps by a predetermined distance, the tap board configured so that only valid connections between the taps are possible and at least one tap is utilized more than once in possible tap connections.

A method for arranging a plurality of taps of a transformer to provide only valid connections has the following steps: providing a tap board having a plurality of openings wherein valid taps are separated by a predetermined distance and invalid tap connections are separated by a distance greater than the predetermined distance; connecting a separate cable having first and second ends at a first end to each one of the plurality of taps extending from a turn of the coil assembly; and mounting the cable second ends through openings in a tap board connected to the transformer enclosure so that a predetermined distance is kept between the valid taps and a distance greater than the predetermined distance is maintained between the invalid taps.

A tap board for arranging a plurality of taps of a transformer, having: a planar board having slots formed therein through which extend corresponding ones of cables having first and second ends, the cable first end connected to a turn on a transformer coil assembly and the cable second end extending through corresponding slots of the tap board for mounting to the tap board to provide a connection surface for connection with other ones of the plurality of taps so that a predetermined distance is kept between valid connections of the plurality of taps.

### BRIEF DESCRIPTION OF THE DRAWINGS

In the accompanying drawings, structural embodiments are illustrated that, together with the detailed description provided below, describe exemplary embodiments of tap configurations for a transformer. One of ordinary skill in the art will appreciate that a component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 is a perspective view of a transformer having a tap board with tap configurations embodied in accordance with the present disclosure;

FIG. 2 is a perspective view of a portion of the tap board and tap connections from exemplary taps K to E on each phase to achieving nominal voltage in the nine tap position configuration;

FIG. 3 is a perspective view of the transformer having the tap board removed;

FIG. 4 is a schematic of a nine position tap configuration;

FIG. 5 is a schematic of a seven position tap configuration; and

FIG. 6 is a schematic of a five position tap configuration.

### DETAILED DESCRIPTION

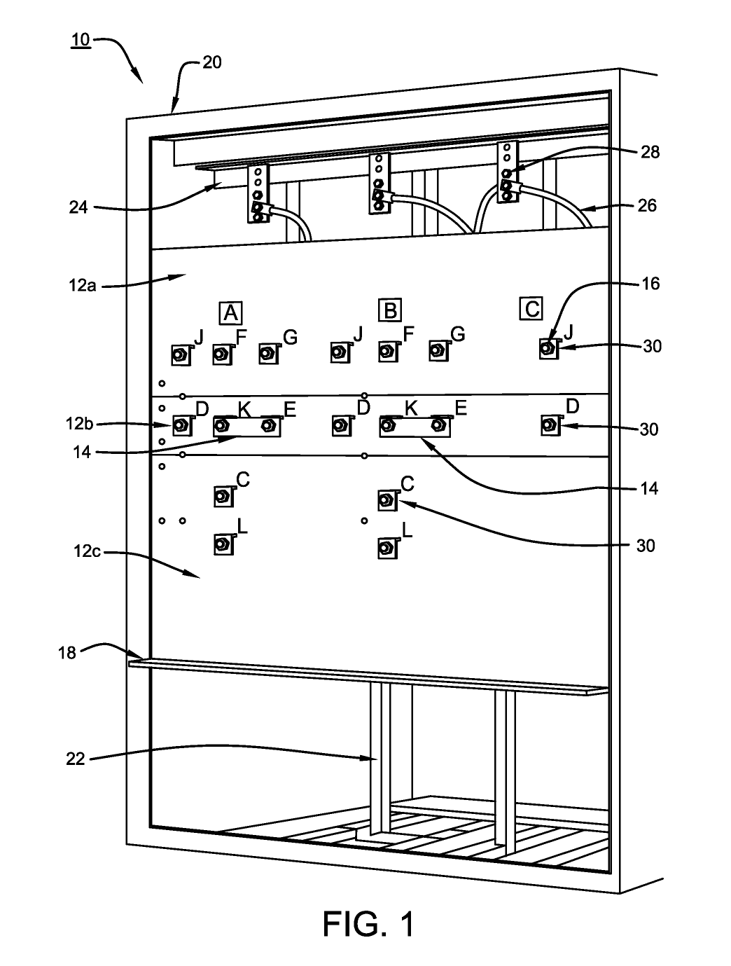

With reference to FIG. 1 and in accordance with the present disclosure, a dry-type transformer 10 having a tap board 12 with a 9-position tap configuration is depicted. The partial view of the tap board 12 does not show the complete set of taps for phase C. However, the set of taps is the same for phase C as is shown for phases A and B. It should be understood that the tap board 12 may be used with a new transformer or retrofit to an existing transformer 10. The exemplary transformer 10 is a three-phase distribution transformer having a nominal voltage of 13,800V on the primary side and 551V on the secondary side and a rating of 3,340 KVA. In one embodiment, the transformer is a rectifier transformer.

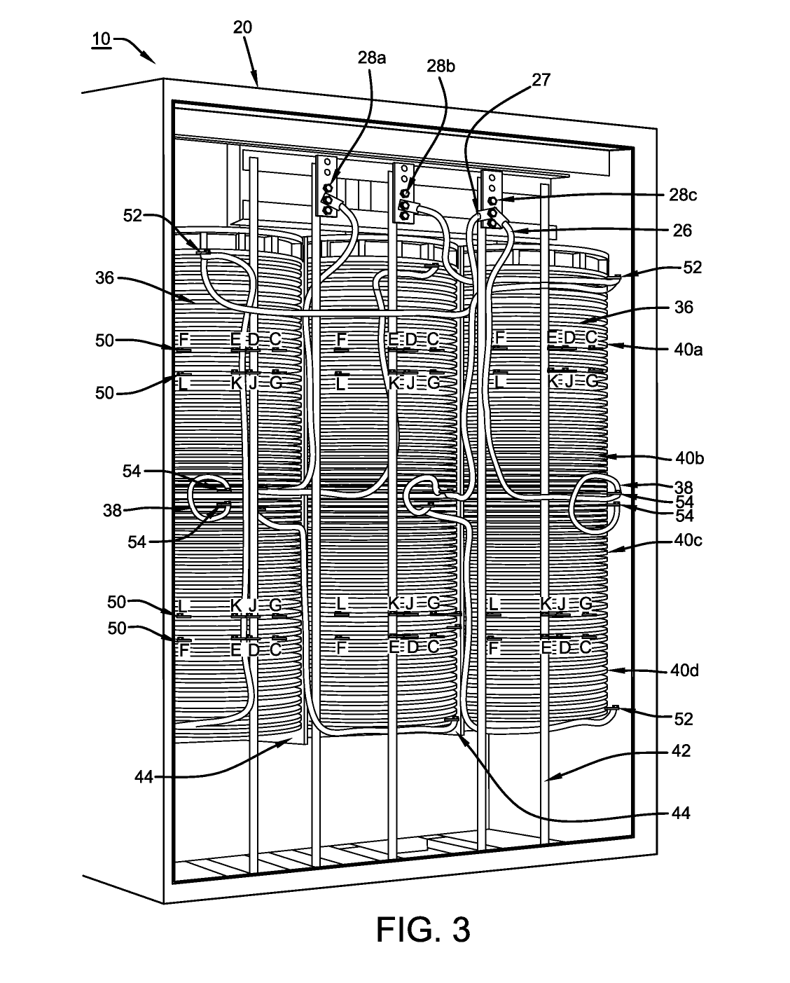

The transformer 10 is housed in an enclosure 20 having top, side and bottom walls. The transformer 10 has a ferromagnetic core having at least one limb connected between upper and lower yokes. The transformer 10 has a coil assembly 36 mounted to the at least one limb. In a three-phase embodiment, there are three coil assemblies 36, each of which is mounted to the corresponding at least one limb. The coil assemblies 36 are formed of primary and secondary coil windings that are arranged concentrically with the secondary coil winding being located internal to the primary coil winding (the primary coil windings are visible in FIG. 3). It should be understood that the transformer 10 may be a single-phase transformer.

The transformer has any one of the following constructions: open wound, vacuum pressure impregnated, vacuum pressure encapsulated or cast coil. An open wound dry-type transformer is fabricated by preheating the coil assemblies 36 and dipping the coil assemblies 36 in varnish. The coil assemblies 36 are then baked to cure the varnish.

In a vacuum pressure impregnation (VPI) process, the coil assembly 36 is coated with a resin such as a polyester resin, an epoxy resin, a silicone resin, an acrylic resin, a polyurethane resin, an imide resin, or a mixture of any of the foregoing. In a VPI process, the coil assembly 36 is first pre-heated in an oven to remove moisture from the coil assembly 36. The coil assembly 36 is then placed in a vacuum chamber, which is evacuated to remove any remaining moisture and gases in the coil assembly 36 and to eliminate any voids between adjacent turns in the disc windings. The resin, in liquid form, is then applied to the coil assembly 36, while the vacuum chamber is still under a vacuum. The resin may be applied to the coil assembly 36 by submerging the coil assembly 36 in a vat filled with the resin. The vacuum is held for a short time interval, which allows the resin to impregnate the coil assembly 36, and then the vacuum is released and the pressure is increased in the vacuum chamber. This will force the resin to impregnate the remaining voids in the coil assembly 36. The coil assembly 36 is then removed from the chamber and is allowed to drip dry. The coil assembly 36 is then placed in an oven to cure the resin.

In a vacuum pressure encapsulation (VPE) process, several dip processes are added to the coil construction process to encapsulate the coil assembly after which the coatings are cured in the oven. A cast coil transformer features coil assemblies 36 that are encapsulated in an epoxy resin by a molding process. For example, the transformer 10 coil assemblies 36 are solidly cast in resin under a vacuum in a mold.

The primary coil winding is disc wound and the secondary coil winding is layer wound from sheets or strips of aluminum or copper. In one embodiment, the secondary coil winding is formed of two coil sections connected together by a bus bar lead. The bus bar lead is welded to strips of conductor that form each of the two sections. The bus bar lead terminates outside of the coil assembly 36. In that same embodiment, the high voltage coil is separated from the low voltage coil by a one inch gap to allow air flow. An electrostatic shield formed of a metal such as stainless steel may be disposed between the primary and secondary coil windings to prevent voltage transients.

The transformer 10 primary winding is a high voltage winding and the secondary winding is a low voltage winding, therefore, the transformer 10 is a so-called “step-down” transformer 10 which steps down the voltage and current values at the output of the transformer 10. Alternatively, the transformer 10 may be embodied as a “step-up” transformer 10 wherein the primary winding is a low voltage winding and the secondary winding is a high voltage winding.

The primary (high voltage) windings are connected together in a delta configuration using cables 26, 27, 54 having lugs on first and second ends and the secondary (low voltage) windings are connected together in a delta configuration (not shown) in the present example. It should be understood that wye, star and other connections are possible, depending on the application.

The tap board 12 creates a barrier between the coil assemblies 36 and the surrounding environment and is formed of 0.25 inch thick glass mat reinforced thermoset polyester sheet that meets or exceeds NEMA GPO-1 properties and is available from Haysite Reinforced Plastics of Erie, Pa. The tap board 12 provides a barrier between the transformer and the surrounding environment as well as permits only safe and valid connections between taps 50.

While the tap board 12 is depicted as a planar wall in front of the transformer 10 coil assemblies 36, the tap board 12 may alternatively be embodied as a partial barrier between the transformer 10 and the surrounding environment or front door of the enclosure 20. The partial barrier tap board 12 connects between side walls of the enclosure and provides enough surface area receive and connect the studs 30 through the tap board 12.

The tap board 12 is supported by a brace 18 that is further connected to the side walls of the enclosure 20 and supports 22 that are connected on a first end to the bottom wall of the enclosure and on a second end to the brace 18 using fasteners or other suitable connections. As shown in FIG. 3, the tap board 12 has partitions 44 joined perpendicularly thereto in relation to the plane of the tap board 12 to provide separation/isolation between the coil assemblies 36. The partitions 44 are further connected to the brace 18. The brace 18 and partitions 44 are formed of the same material as the tap board 12 whereas the supports 22 are formed of metal channel members.

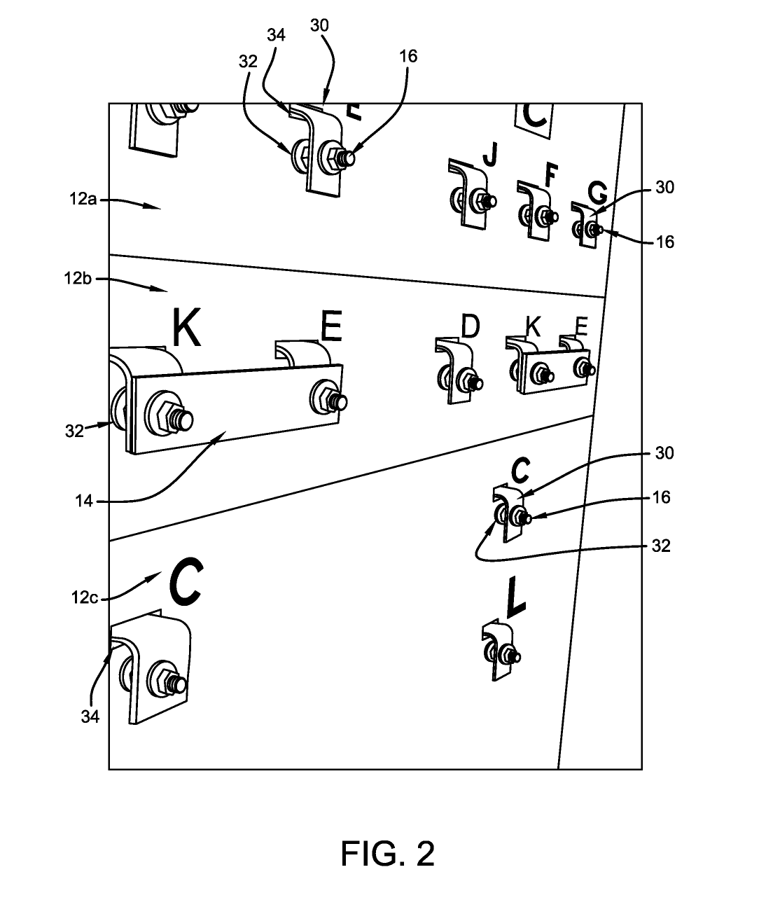

Slots 34 (shown in FIG. 2) are cut into the tap board 12 using the waterjet process mentioned above. The slots 34 receive the studs 30 corresponding to the respective taps 50. Taps 50 are provided on the primary side of the transformer 10 to adjust the service voltage at the input of the transformer 10 although it should be understood the tap configuration disclosed herein may be utilized on the secondary side of the transformer 10.

The taps allow adjustments in 2.5% increments below and above the nominal voltage. In the present example wherein taps 50 are connected in parallel to the corresponding studs 30, the nominal voltage is 13,800 Volts and a tap bar 14 connecting taps E and K on each coil winding represents the connection to achieve nominal voltage at the input or bus bars 28a, 28b, 28c for the phases a, b, and c. It should be understood that in a series tap connection there are two sets of connections using a tap bar 14 between first and second sets of taps E and K for each phase.

With reference to FIGS. 2 and 3, taps 50 labeled C, D, E, F, G, J, K, L represent positions along a coil winding where connections are made to achieve a desired turns ratio, and as a result, a specific output voltage. Each tap 50 is connected to the tap board 12 using a cable having first and second ends. In the case of tap 50 connections made in parallel as is depicted in FIGS. 2 and 3, the first end of the cable is connected to the respective turn of the coil winding from which tap 50 extends and the second end of the cable is connected to a stud 30 which is slipped through the corresponding slot 34 and further secured to the tap board 12 using a fastener 16.

As shown in FIG. 3, the high voltage coil windings of each coil assembly 36 have taps A, B, C, D, E, F, G, J, K, and L. Tap A 52 is the start of the high voltage winding and tap B 54 is the end of the high voltage winding. The high voltage winding has four sections of discs 40a, 40b, 40c, 40d with each section having an equal number of discs. The second and third sections of discs 40b, 40c are connected together in parallel by a jumper cable 38.

With continued reference to FIGS. 2 and 3, a partial view of the tap board 12 shows three sections 12a, 12b, and 12c wherein each tap 50 of a first set of taps 50 is brought to a parallel connection with each corresponding tap 50 of a second set of taps 50 on a single stud 30 of the tap board 12. The sections 12a, 12b, 12c are cut to a predetermined size using a waterjet machine applying high pressure water and grit.

The first and second sets of taps 50 extend from the desired turn positions on each high voltage coil winding. The first set of taps 50 (in the order F,E,D,C,L,K,J,G) is located between the first section of the coil 40a and the second section of the coil 40b and the second set of taps 50 (in the order L,K,J,G,F,E,D,C) is located between the third section of the coil 40c and the fourth section of the coil 40d on each high voltage coil winding.

Each of the taps 50 in the first and second sets of taps 50 is connected to the respective stud 30 positioned on the tap board 12 by a cable having first and second ends that are lugs. The cable is formed of a conductive metal and is insulated except for the first and second ends which lugs and used to make the electrical connections.

Each stud 30 has a first and second ends, the second end connected to the respective tap 50 and the first end extending through the corresponding slots 34 on the tap board 12. The studs 30 are formed of bronze or stainless steel and are flat at the second end and curve downwardly to the flat first end. The stud 30 first end is a connection surface for connecting the respective taps 50 together to achieve the desired voltage. Fasteners 16, nuts, and washers 32 are used to secure the stud 30 and tap bars 14 in position through apertures on the tap board 12. The tap bars 14 are formed of silver-plated copper and are of a predetermined length corresponding to the separation between the studs 30 in order to permit only valid tap connections.

A method for arranging a plurality of taps of a transformer to provide only valid connections has the following steps. A tap board 12 having a plurality of openings wherein valid taps are separated by a predetermined distance and invalid tap connections are separated by a distance greater than the predetermined distance. A separate cable having first and second ends is connected at a first end to each one of the plurality of taps extending from a turn of the coil winding. The cable second ends are mounted through openings in a tap board connected to the transformer enclosure so that a predetermined distance is kept between the valid taps and a distance greater than the predetermined distance is maintained between the invalid taps.

An example of a tap connection made in parallel is a first cable first end connected to the tap “E” in the first set of taps 50 and a first cable second end connected to the stud 30 mounted at tap position “E” on the tap board 12 and a second cable connecting the tap “E” in the second set of taps 50 at a first end to the same stud 30 at a cable second end, the stud 30 corresponding to position “E” on the tap board 12. The first and second cable second ends are connected to the “E” stud 30 behind the tap board 12 using a fastener that is passed through the openings in the cable second ends and the opening in the stud 30 second end. The stud 30 first end is for securing the tap bars 14 that connect the respective studs 30 together to achieve the desired output voltage. Each of the corresponding taps 50 in the first and second set of taps 50 are connected to the same single stud in a tap parallel connection.

Alternatively, when the taps 50 are connected together in series, the tap board 12 has three or more sections. For example, the tap board 12 may have six sections to accommodate eight rows of studs 30 in a series tap connection arrangement. The eight rows of taps 50 are the four rows depicted in FIG. 1 and are repeated to accommodate the series tap connections. The taps 50 are positioned linearly within each row.

When the taps 50 are connected together in series, there is a single cable connecting each tap 50 to the corresponding stud 30 on the tap board 12. The cable first end is connected to the respective tap 50 in the first set of taps 50 and the cable second end is connected to the corresponding stud 30 position from behind the tap board 12. Using tap “E” as an example, the first tap “E” on the first high voltage coil winding is connected by a cable first end to a stud at position “E” on the tap board 12. The second tap “E” on the first high voltage coil winding is connected by a second cable first end to the second “E” stud position in the tap board 12.

Table 1 below provides exemplary tap connections and corresponding voltage values achieved by the tap connections when the same tap connections are made between each of the three phases. It should be understood that other tap connections and voltage values are possible, depending on the application.

TABLE 1

| Voltage | Tap Connection |
|---|---|
| 15,180 | F to G |
| 14,835 | E to G |
| 14,490 | F to J |
| 14,145 | F to K |
| 13,800 | E to K |
| 13,455 | D to J |
| 13,110 | D to K |
| 12,765 | C to K |
| 12,420 | C to L |

In order to prevent invalid tap connections from being made, the taps are spaced apart so as to only allow valid connections using the tap bars 14 of a predetermined length. For example, invalid tap connections are spaced farther apart than the length of the tap bar will allow at X*√2 apart wherein the distance between “valid tap connections” is X. The primary voltage basic impulse level (BIL) in the exemplary transformer 10 equals 110 KV and the clearance between each tap is a predetermined distance based on the BIL and in accordance with IEEE Std. C57-12.01.

While the tap configurations/arrangements disclosed herein generally form a quadrilateral shape, such as a square, rectangular or rhombic shape, it should be understood that the tap configurations are exemplary and other tap configurations are contemplated. For example, any tap configuration in which the predetermined distance relationship between any of two taps in a plurality of taps results in only valid tap connections being possible, is contemplated.

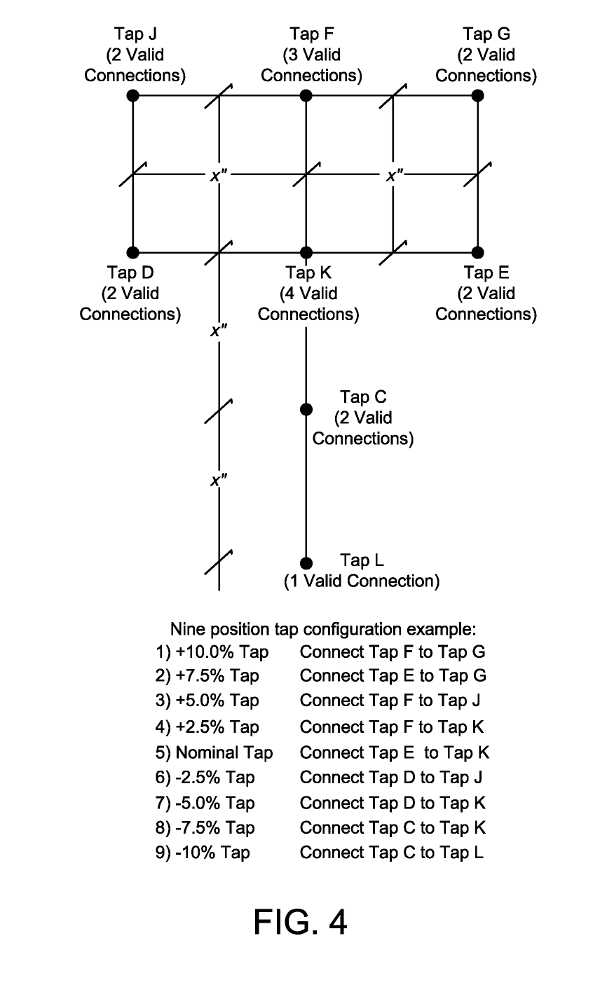

The tap configuration allows for the reduction of two studs 30 per coil in a nine-position tap configuration in relation to prior tap arrangements utilizing a standard tap configuration that required 10 studs 30 per high voltage coil. The standard tap configuration is shown in FIG. 7 for a high-voltage coil having taps J, G, K, F, L, E, M, D, N, and C wherein the taps can be connected as follows: J to G, G to K, K to F, F to L, L to E, E to M, M to D, D to N and N to C. In contrast, the nine-position tap configuration of FIGS. 1 and 4 has 8 studs per coil when the taps are connected together in parallel.

With reference now to FIG. 2, a tap bar 14 is shown as connecting taps E and on each phase to produce a nominal voltage. The tap bar 14 has first and second ends each having an opening disposed therein for receiving a fastener 16 to secure the tap bar 14 as well as connect the stud 30 to the tap board 12. Each side of the tap bar 14 opening has a washer 32 and a nut placed thereon and a fastener 16 secures the assembly to the tap board 12.

Referring now to FIG. 3, the transformer 10 is shown having the tap board 12 removed and the enclosure open. The transformer has three coil assemblies 36 formed of primary and secondary windings as previously described. The primary coil windings are on the exterior and are formed of multiple discs each having a number of turns per disc. Each primary coil winding has four sections 40a, 40b, 40c having an equal number of discs. The discs are connected to other discs by cables 38 in a parallel connection.

With reference now to FIG. 4, a nine position tap configuration schematic is shown. Each of the taps C, D, E, F, G, J, K, and L may be connected to certain ones of the other taps 30 due to the separation distance “X” between the taps. As previously mentioned, only the valid or permitted tap connections are possible, including: Tap F connected to Tap G, Tap E connected to Tap G, Tap F connected to Tap J, Tap F connected to Tap K, Tap E connected to Tap K, Tap D connected to Tap J, Tap D connected to Tap K, Tap C connected to Tap K, and Tap C connected to Tap L. As the tap configuration allows Taps F and K to be used more in more than two possible connections, the amount of studs 30 used is reduced by two on each coil for the nine-position tap configuration. Previously each high voltage coil would have used 10 studs per coil winding for a total of 30 studs in a three-phase transformer 10 whereas using the present method allows for 8 studs per coil for a total of 24 studs.

The tap configuration of FIG. 4 is a rectangle bisected by a valid tap connection between tap F and tap K to form two squares. Each square has a tap at each corner. Taps C and L are aligned with tap K in a linear fashion.

The valid connections between the taps provide the voltage value in relation to the nominal voltage provided by a connection from Tap E to Tap K, as follows: the connection of Tap F to Tap G provides a +10 percent increase in voltage, the connection of Tap E to Tap G provides a +7.5 percent increase in voltage, the connection of Tap F to Tap J provides a +5 percent increase in voltage, the connection of Tap F to Tap K provides a +2.5 percent increase in voltage, the connection of Tap D to Tap J provides a −2.5 percent decrease in voltage, the connection of Tap D to Tap K provides a −5 percent decrease in voltage, the connection of Tap C to Tap K provides a −7.5 percent decrease in voltage, and the connection of Tap C to Tap L provides a −10 percent decrease in voltage.

It should be understood that in order to achieve the desired voltage at the input or output of a three-phase transformer, all three phases must have the same tap connections, as is shown in part in FIG. 1 wherein tap K is connected to tap E for phases A and B, but should also be connected tap K to tap E for phase C.

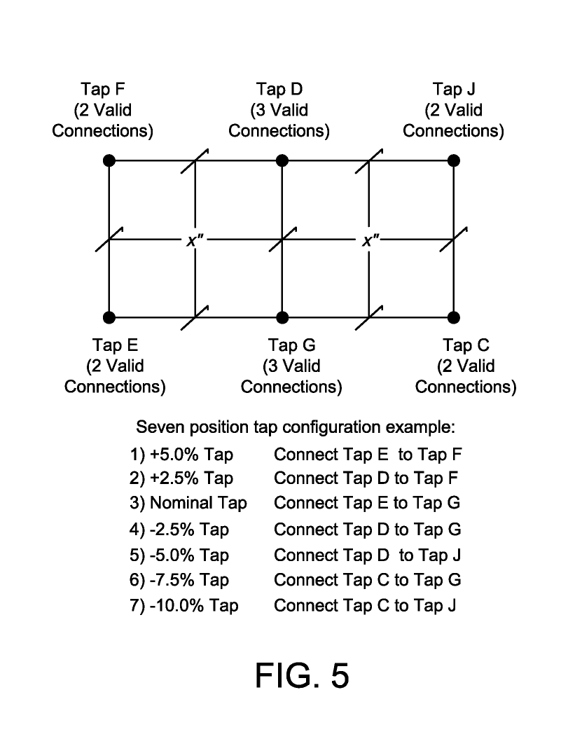

With reference now to FIG. 5, a seven position tap configuration is shown. It should be noted that the seven position tap configuration utilizes a tap board 12 having only two sections wherein taps F, D, and J are located in a row in a first second and taps E, G, and C are located in a row in the second section. The available tap connections are: Tap E connected to Tap F providing a +5.0% increase in voltage from the nominal voltage, Tap D connected to Tap F providing a +2.5% increase in voltage from the nominal voltage, nominal tap connection of Tap E to Tap G, Tap D connected to Tap G to provide a −2.5% decrease in voltage from the nominal voltage, Tap D connected to Tap J to provide a −5.0% decrease in voltage from the nominal voltage, Tap C connected to Tap G to provide a −7.5% decrease in voltage from the nominal voltage, and Tap C connected to Tap J to provide a −10% decrease in voltage from the nominal voltage.

The tap configuration of FIG. 5 is a rectangle bisected by a valid tap connection between tap D and tap G to form two squares. Each square has a tap at each corner.

The seven position tap configuration utilizes 6 studs 30 per coil winding for a total of 18 studs in a three phase transformer whereas the standard tap configuration uses eight studs per coil winding for a total of 24 studs. Therefore the seven position tap configuration saves six studs 30.

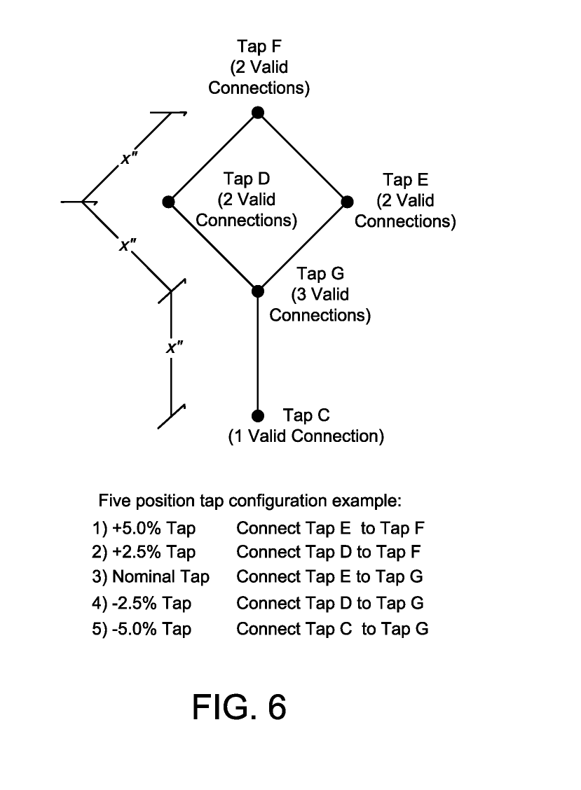

Referring now to FIG. 6, a five position tap configuration is shown. The available tap connections are: Tap E to Tap F providing a +5.0% increase in voltage from the nominal voltage, Tap D to Tap F providing a +2.5% increase in voltage from the nominal voltage, Tap E to Tap G providing nominal voltage, Tap D to Tap G providing a −2.5% decrease in voltage from the nominal voltage, and Tap C to Tap G providing a −5.0% decrease in voltage from the nominal voltage.

The five position tap configuration uses five studs per coil winding for a total of 15 studs whereas the standard tap configuration uses six studs per coil winding. Therefore, the five position tap configuration saves three studs. The tap configuration of FIG. 6 is a square that has been rotated 45 degrees. The square has a tap at each corner and an additional tap extending in a linear fashion from one of the corners of the square.

It should be understood that the five, seven, or nine position tap configuration is selected based on the requirements of the particular application.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application illustrates various embodiments, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative embodiments, and illustrative examples shown and described. Accordingly, departures may be made from such details without departing from the spirit or scope of the applicant's general inventive concept.

What is claimed is:

1. A transformer, comprising:
a core having at least one core limb extending between upper and lower yokes;
a coil assembly mounted to each at least one core limb;
a plurality of taps extending from the surface of the coil assembly;
at least one cable having first and second ends, the at least one cable first end connected to a corresponding tap at a turn on the coil assembly and the cable second end providing a connection surface for connecting with other ones of the taps; and
a tap board having slots through which corresponding ones of the cable second ends extend to provide a connection surface, each of the taps positioned apart from other ones of the taps by a predetermined distance, the tap board configured so that only valid connections between the taps are possible and at least one tap is utilized more than once in possible tap connections.

2. The transformer of claim 1 wherein each of the plurality of taps is one of separated from other ones of the plurality of taps that would result in an invalid tap connection by a predetermined distance that is greater than the length of a tap connector for connecting two taps and separated by from other ones of the plurality of taps by a predetermined distance that is equal to the length of a tap connector for connecting two taps.

3. The transformer of claim 2 wherein each of the plurality of taps is one of separated by a distance of a predetermined length from other ones of the taps for a valid tap connection and separated by a distance of a predetermined length multiplied by about 1.4 from other ones of the taps that would result in an invalid connection.

4. The transformer of claim 2 wherein each of the taps providing valid connections with other ones of the taps are positioned for connection with more than one possible other tap to form a valid tap connection.

5. The transformer of claim 1 wherein the tap board is constructed of a thermoset polyester material.

6. The transformer of claim 1 wherein the plurality of taps are arranged in the shape of a quadrilateral.

7. The transformer of claim 1 wherein the plurality of taps are arranged in a square configuration.

8. The transformer of claim 1 wherein the plurality of taps are arranged in a rectangular configuration.

9. The transformer of claim 1 wherein the plurality of taps are arranged in a rhombic configuration.

10. A method for arranging a plurality of taps of a transformer to provide only valid connections has the following steps:
a. Providing a tap board having a plurality of openings wherein valid taps are separated by a predetermined distance and invalid tap connections are separated by a distance greater than the predetermined distance;
b. Connecting a separate cable having first and second ends at a first end to each one of the plurality of taps extending from a turn of the coil assembly; and
c. Mounting the cable second ends through openings in a tap board connected to the transformer enclosure so that a predetermined distance is kept between the valid taps and a distance greater than the predetermined distance is maintained between the invalid taps.

11. The method of claim 10 wherein the plurality of taps are arranged in a quadrilateral configuration.

12. The method of claim 11 wherein the plurality of taps are arranged in a quadrilateral configuration and having an additional tap arranged linearly in relation to one of the plurality of taps of the quadrilateral configuration.

13. A tap board for arranging a plurality of taps of a transformer, comprising: a planar board having slots formed therein through which extend corresponding ones of cables having first and second ends, the cable first end connected to a turn on a transformer coil assembly and the cable second end extending through corresponding slots of the tap board for mounting to the tap board to provide a connection surface for connection with other ones of the plurality of taps so that a predetermined distance is kept between valid connections of the plurality of taps.

14. The tap board of claim 13 wherein the plurality of taps are arranged in a quadrilateral configuration.

15. The tap board of claim 14 wherein the plurality of taps are arranged in a quadrilateral configuration and have at least one additional tap separated from the plurality of taps by a predetermined distance.
